(19) United States
(12) Patent Application Publication
(10) Pub. No.: US 2015/0360271 A1
(43) Pub. Date: Dec. 17, 2015

(54) CURVED LIGHT EMITTING DIODE FIXTURE

(71) Applicants: James Bradford Hawkins, Liberty, MO (US); Jeremy Daniel Langton, Liberty, MO (US)

(72) Inventors: James Bradford Hawkins, Liberty, MO (US); Jeremy Daniel Langton, Liberty, MO (US)

(21) Appl. No.: 14/302,562

(22) Filed: Jun. 12, 2014

(51) Int. Cl. B21D 1/12; F21V 5/04; F21V 21/30; F21L 14/02; F21V 23/04

(52) U.S. Cl. CPC B21D 1/12; F21L 14/026; F21V 23/0414; F21V 21/30; F21V 5/04; F21Y 2103/025

(57) ABSTRACT

A curved light emitting diode fixture. Particularly, the application provides a curved light emitting diode (LED) fixture for paint less dent repair (PDR) in automobiles. More particularly, the present application provides a curved light emitting diode (LED) fixture for providing multi directional light to illuminate dents on automotive vehicles while repairing such dents.

### FIELD OF THE INVENTION

The present application generally relates to the field of light emitting diode (LED) fixtures. Particularly, the application provides a curved light emitting diode (LED) fixture for paint less dent repair (PDR) in automobiles or any other vehicles. More particularly, the application provides a curved light emitting diode (LED) fixture for providing multi directional light to illuminate dents on automotive vehicles while repairing such dents.

### BACKGROUND

Recent years have witnessed a tremendous growth in vehicular population across the globe, which has resulted in significant increase of vehicular accidents or damage caused by hail or other natural occurrences. The vehicular accidents may be categorized based upon the degree of damage. Unlike the heavily damaged vehicles, small dents can be repaired easily with the help of paint less dent repair (PDR) tools and techniques. The paint less dent repair (PDR) is a collection of standard techniques for removing minor dents from an automotive vehicle. With the advent of technology, variety of dent damages can be repaired using PDR. Amongst others, an efficient and effective light source is one of the essential tools while repairing and affirming the repaired dent of the automotive vehicle.

The existing light sources used by professional dent repair technicians are linear. A linear light source provides light in unidirectional manner and does not illuminate the dent appropriately on vehicular body. In such scenario, the dent repair technicians is required to move the light source or light fixture many a times. An alternative could be to use two light sources at a time instead of one to create multi directional light beams to better visualize and ensure that the dent has been repaired.

Prior art literature doesn't illustrate of solutions wherein a single light source could serve the purpose, further at least two light fixtures are required or one has to move the one fixture many a times to identify if the dent is truly repaired or not. Prior art only provides linear light fixtures wherein the light source projects straight ahead with no cross beams.

Thus, in the light of the above mentioned background discussion, it is evident that, there is a need for a lighting fixture which could provide multi directional light to illuminate dents on automotive vehicles while repairing such dents. A curved light emitting diode (LED) fixture is desired for paint less dent repair (PDR) in automobiles.

### SUMMARY

Before the present systems and methods, enablement are described, it is to be understood that this application is not limited to the particular systems, and methodologies described, as there can be multiple possible embodiments which are not expressly illustrated in the present disclosures. It is also to be understood that the terminology used in the description is for the purpose of describing the particular versions or embodiments only, and is not intended to limit the scope of the present application.

In accordance with the present application, the primary objective is to provide a curved light emitting diode (LED) fixture for paint less dent repair (PDR) in automobiles or any other types of vehicles.

Another objective is to provide a curved light emitting diode (LED) fixture for paint less dent repair (PDR) in vehicles which could provide multi directional light to illuminate dents on automotive vehicle surfaces while repairing such dents.

In an embodiment of the present invention, a curved light emitting diode (LED) fixture for paint less dent repair (PDR) in vehicles comprises of a curved, rectangular shaped housing component (102) further having a perpendicular extension (122) at both the edges of longer arm of said curved, rectangular shaped housing component (102); at least three strips of LEDs (104) affixed along with upper and lower edge of said rectangular shape housing component (102), along with length of said rectangular shape housing component (102), for providing multi directional light to illuminate dents on automotive vehicles; a white translucent lens (106), secured on a raceway (124) affixed to inner surface of the perpendicular extension (122) of said rectangular shape housing component (102) for accommodating the white translucent lens (106); wherein the white translucent lens (106) is covering at least three strips of LEDs (104) affixed along with upper and lower edge of said rectangular shape housing component (102); wiring for providing electric supply to said at least three strips of LEDs (104) and other components of said curved light emitting diode LED fixture (100); at least two rubber cushion bumper (108) affixed to outer surface of the perpendicular extension (122) of said rectangular shape housing component (102) for ensuring scratch less operation of said curved LED fixture (100) when used without a stand and laid on a painted surface of automobile; a set of power switches (110) affixed at the back of said rectangular shape housing component (102) for switching on, off and dimming said at least three strips of LEDs (104) affixed along with upper and lower edge of said rectangular shape housing component (102); a power cord for providing electricity supply to at least three strips of LEDs (104) affixed along with upper and lower edge of said rectangular shape housing component (102); a brass pivotal ball (112) affixed in middle of said housing component (102) with the help of a nut (118) and bolt (120) for enabling said curved LED fixture (100) to rotate at different angles when affixed with a stand; a pair of metal plates (114) affixed in the middle of said rectangular shape housing component (102), from front and back side of said rectangular shape housing component (102) for supporting the brass pivotal ball (112) on said rectangular shape housing component (102) and passing through the power cord; and a pair of side cap (126) affixed on the both edges of the perpendicular extension (122) of said rectangular shape housing component (102) for covering opened space left between the curved, rectangular shaped housing component (102) and white translucent lens (106).

The above said curved light emitting diode (LED) fixture is provided for paint less dent repair (PDR) in automotive vehicles but also can be used for many other applications.

### BRIEF DESCRIPTION OF THE DRAWINGS

The foregoing summary, as well as the following detailed description of preferred embodiments, is better understood when read in conjunction with the appended drawings. There is shown in the drawings example embodiments, however, the application is not limited to the specific system and method disclosed in the drawings.

FIG. 1: shows a front view of a curved light emitting diode (LED) fixture without a white translucent lens.

FIG. 2: shows a front view of a curved light emitting diode (LED) fixture with a white translucent lens.

FIG. 3: shows a back perspective view of a curved light emitting diode (LED) fixture.

FIG. 4: shows a back view of a curved light emitting diode (LED) fixture.

FIG. 5: shows a close up of back view of a curved light emitting diode (LED) fixture.

FIG. 6: shows a close up of a brass pivotal ball of a curved light emitting diode (LED) fixture.

FIG. 7: shows a lateral view of a curved light emitting diode (LED) fixture.

FIG. 8: shows an exploded view of a curved light emitting diode (LED) fixture.

FIG. 9: shows a wiring diagram of a curved light emitting diode (LED) fixture.

### DETAILED DESCRIPTION

Some embodiments, illustrating its features, will now be discussed in detail. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items. It must also be noted that as used herein and in the appended claims, the singular forms “a,” “an,” and “the” include plural references unless the context clearly dictates otherwise. Although any methods, and systems similar or equivalent to those described herein can be used in the practice or testing of embodiments, the preferred methods, and systems are now described. The disclosed embodiments are merely exemplary.

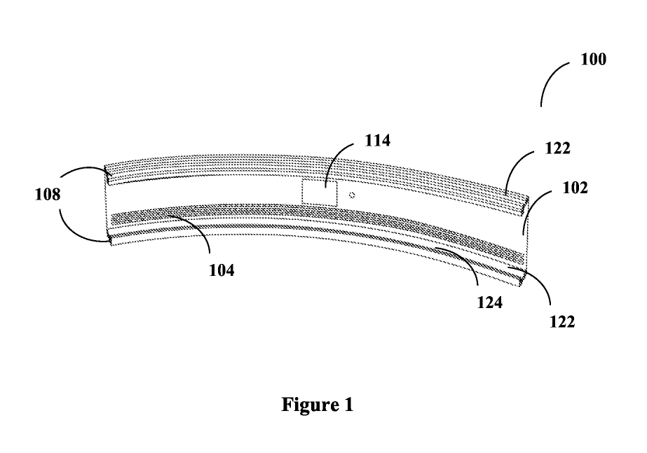

Referring to FIG. 1 is a front view of a curved light emitting diode (LED) fixture without a white translucent lens.

In an embodiment of the present invention, a curved light emitting diode (LED) fixture (100) for paint less dent repair (PDR) in automobiles is provided which is characterized in providing multi directional light to illuminate dents on automotive vehicles while repairing such dents.

In another embodiment of the present invention, the curved light emitting diode (LED) fixture (100) comprises of a curved, rectangular shaped housing component (102). The rectangular shape housing component (102) is further having a perpendicular extension (122) at both the edges of longer arm. The curved, rectangular shaped housing component (102) is manufactured from a material selected from a group comprising of polycarbonate, polypropylene and combination thereof.

In another embodiment of the present invention, at least three strips of LEDs (104) are affixed along with upper and lower edge of said curved rectangular shape housing component (102), along with length of said rectangular shape housing component (102), for providing multi directional light to illuminate dents on automotive vehicles.

The each LED strip out of the at least three strips of LEDs (104) affixed along with upper and lower edge of said rectangular shape housing component (102) is 120 cm long and evenly spaced from each end of said rectangular shape housing component (102).

Each LED of said at least three strips of LEDs (104) affixed along with upper and lower edge of said rectangular shape housing component (102) is selected from a group comprising of but not limited to white, yellow, blue, green colored LEDs and combination thereof.

The each LED strip out of the at least three strips of LEDs (104) affixed along with upper and lower edge of said rectangular shape housing component (102) is DC 12V-3528 or 3020 of lumen.

The at least three strips of LEDs (104) affixed along with one of edge out of the upper and lower edge of said rectangular shape housing component (102) further comprises of two LED strips of 3000 degree kelvin on the outside with one 6500 degree kelvin LED strip running in the middle.

The at least three strips of LEDs (104) affixed along with the other edge out of the upper and lower edge of said rectangular shape housing component (102) further comprises of two LED strips of 6500 degree kelvin on the outside with one 3000 degree kelvin LED strip running in the middle.

In another embodiment of the present invention, at least two rubber cushion bumper (108) affixed to outer surface of the perpendicular extension (122) of said rectangular shape housing component (102) for ensuring scratch less operation of said curved LED fixture (100) when used without a stand and laid on a painted surface of automobile.

In another embodiment of the present invention, a raceway (124) affixed to inner surface of the perpendicular extension (122) of said rectangular shape housing component (102) for accommodating a white translucent lens (106) (not shown in FIG. 1), wherein said white translucent lens (106) (not shown in FIG. 1) is covering at least three strips of LEDs (104) affixed along with upper and lower edge of said rectangular shape housing component (102), wiring for providing electric supply to said at least three strips of LEDs (104) and other components of said curved LED fixture (100).

In another embodiment of the present invention, a pair of metal plates (114) affixed in the middle of said rectangular shape housing component (102), from front and back side of said rectangular shape housing component (102) for supporting a brass pivotal ball (112) (not shown in the FIG. 1) on said rectangular shape housing component (102) and having a passageway for passing through a power cord. The pair of metal plate (112) affixed in the middle of said rectangular shape housing component (102) is manufactured from a material selected from a group comprising of power coated aluminum and steel. The pair of metal plate (112) is having dimensions of 100 mm of length, 75 mm of width and 2 mm of thickness.

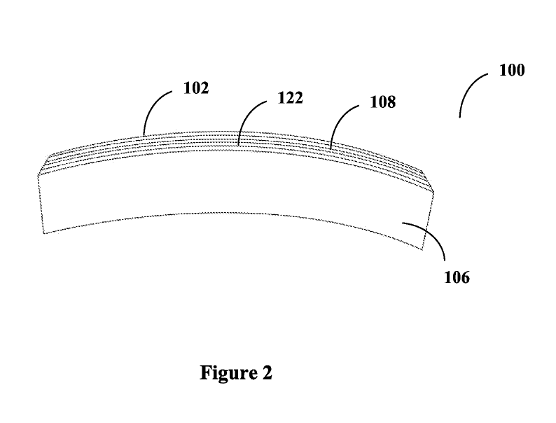

Referring to FIG. 2 is a front view of a curved light emitting diode (LED) fixture with a white translucent lens.

In another embodiment of the present invention, the white translucent lens (106) is secured and affixed on the raceway (124) (not shown in FIG. 2) affixed to inner surface of the perpendicular extension (122) of said rectangular shape housing component (102).

The white translucent lens (106) is covering at least three strips of LEDs (104) affixed along with upper and lower edge of said rectangular shape housing component (102), wiring for providing electric supply to said at least three strips of LEDs (104) and other components of said curved light emitting diode LED fixture (100). The white translucent lens (106) is of the equal size of said housing component (102). The white translucent lens (106) is manufactured from a material selected from a group comprising of acrylic.

At least two rubber cushion bumper (108) affixed to outer surface of the perpendicular extension (122) of said rectangular shape housing component (102) for ensuring scratch less operation of said curved LED fixture (100) when used without a stand and laid on a painted surface of automobile.

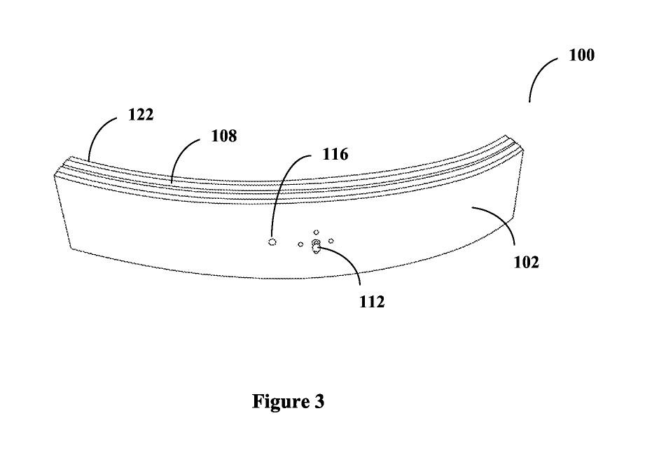

Referring to FIG. 3 is a back perspective view of a curved light emitting diode (LED) fixture.

The curved light emitting diode (LED) fixture (100) comprises of the curved, rectangular shaped housing component (102) and the white translucent lens (106) (not shown in FIG. 3), covering at least three strips of LEDs (104) affixed along with upper and lower edge of said rectangular shape housing component (102), wiring for providing electric supply to said at least three strips of LEDs (104) and other components of said curved light emitting diode LED fixture (100).

In another embodiment of the present invention, the brass pivotal ball (112) affixed in middle of said housing component (102) with the help of a nut (118) and bolt (120) (not shown in the FIG. 3) for enabling said curved LED fixture (100) to rotate at different angles when affixed with a stand, and incorporates the ability to attach said curved LED fixture (100) to all existing light stands which are common in the industry.

In another embodiment of the present invention, the power cord (not shown in the FIG. 3) passes through an aperture (116) in the said rectangular shape housing component (102) and the pair of metal plate (114) affixed in the middle of said rectangular shape housing component (102).

In another embodiment of the present invention, the power cord (not shown in the FIG. 3) provides electricity supply to at least three strips of LEDs (104) affixed along with upper and lower edge of said rectangular shape housing component (102) is 500 cm long coiled cord and comprising of 16 or 14 gauge insulated copper wire.

In another embodiment of the present invention, the power cord (not shown in the FIG. 3) for providing electricity supply to at least three strips of LEDs (104) affixed along with upper and lower edge of said rectangular shape housing component (102) has 12 v automotive cigarette lighter male plug on the end.

At least two rubber cushion bumper (108) affixed to outer surface of the perpendicular extension (122) of said rectangular shape housing component (102) for ensuring scratch less operation of said curved LED fixture (100) when used without a stand and laid on a painted surface of automobile.

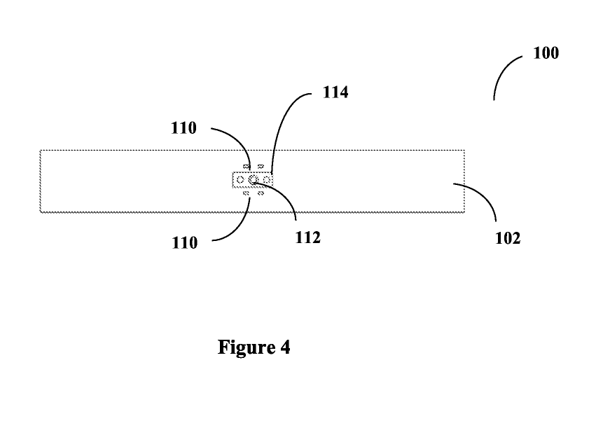

Referring to FIG. 4 is a back view of a curved light emitting diode (LED) fixture.

In another embodiment of the present invention, the curved, rectangular shaped housing component (102) of the curved light emitting diode (LED) fixture (100) for paint less dent repair (PDR) in automobiles comprises of a set of power switches (110) affixed at the back of said rectangular shape housing component (102) for switching on, off and dimming said at least three strips of LEDs (104) affixed along with upper and lower edge of said rectangular shape housing component (102).

In another embodiment of the present invention, the set of power switches (110) further comprises of one power switch (130) (not shown in the FIG. 4) operating two LED strips on the outside (104a) (not shown in the FIG. 4) out of said at least three strips of LEDs (104) affixed along with upper and lower edge of said rectangular shape housing component (102); second power switch (132) (not shown in the FIG. 4) operating one LED strip running in the middle (104b) (not shown in the FIG. 4) out of said at least three strips of LEDs (104) affixed along with upper and lower edge of said rectangular shape housing component (102); and a master switch a dimmer (128) (not shown in the FIG. 4) acting as dimming controller for said at least three strips of LEDs (104) affixed along with upper and lower edge of said rectangular shape housing component (102).

The curved, rectangular shaped housing component (102) further comprises of the brass pivotal ball (112) affixed in middle of said housing component (102) with the help of a nut (118) and bolt (120) for enabling said curved LED fixture (100) to rotate at different angles when affixed with a stand; and the pair of metal plate (114) affixed in the middle of said rectangular shape housing component (102), from front and back side of said rectangular shape housing component (102) for supporting the brass pivotal ball (112) on said rectangular shape housing component (102) and passing through the power cord.

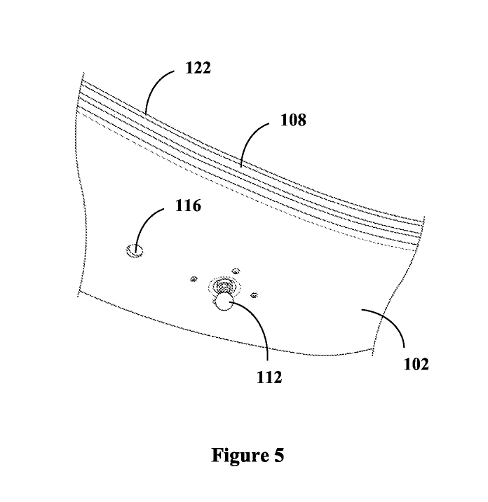

Referring to FIG. 5 is a close up of back view of a curved light emitting diode (LED) fixture.

The curved, rectangular shaped housing component (102) comprises of the brass pivotal ball (112) affixed in middle of said housing component (102) with the help of a nut (118) and bolt (120) (not shown in FIG. 5) for enabling said curved LED fixture (100) to rotate at different angles when affixed with a stand; and the aperture (116) in the said rectangular shape housing component (102) for passing through the power cord (not shown in the FIG. 5).

At least two rubber cushion bumper (108) affixed to outer surface of the perpendicular extension (122) of said rectangular shape housing component (102) for ensuring scratch less operation of said curved LED fixture (100) when used without a stand and laid on a painted surface of automobile.

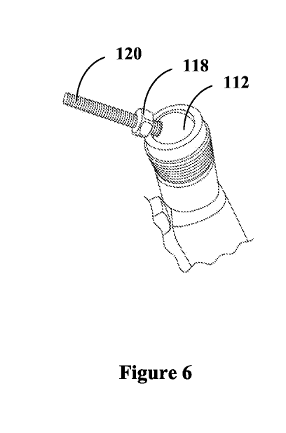

Referring to FIG. 6 is a close up of a brass pivotal ball of a curved light emitting diode (LED) fixture.

In another embodiment of the present invention, the brass pivotal ball (112) affixed in middle of said housing component (102) with the help of a nut (118) and bolt (120) for enabling said curved LED fixture (100) to rotate at different angles when affixed with a stand.

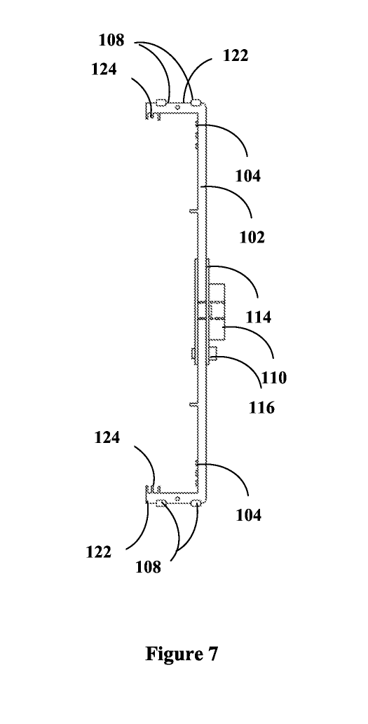

Referring to FIG. 7 is a lateral view of a curved light emitting diode (LED) fixture.

In another embodiment of the present invention, the curved, rectangular shaped housing component (102) is further having said perpendicular extension (122) at both the edges of longer arm. At least three strips of LEDs (104) are affixed along with upper and lower edge of said curved rectangular shape housing component (102), along with length of said rectangular shape housing component (102), for providing multi directional light to illuminate dents on automotive vehicles. At least two rubber cushion bumper (108) affixed to outer surface of the perpendicular extension (122) of said rectangular shape housing component (102) for ensuring scratch less operation of said curved LED fixture (100) when used without a stand and laid on a painted surface of automobile. The raceway (124) affixed to inner surface of the perpendicular extension (122) of said rectangular shape housing component (102) for accommodating a white translucent lens (106) (not shown in FIG. 7). The pair of metal plates (114) affixed in the middle of said rectangular shape housing component (102), from front and back side of said rectangular shape housing component (102) for supporting a brass pivotal ball (112) (not shown in the FIG. 7) on said rectangular shape housing component (102) and having the aperture (116) for providing passageway for passing through a power cord (not shown in the FIG. 7). The set of power switches (110) affixed at the back of said rectangular shape housing component (102) for switching on, off and dimming said at least three strips of LEDs (104) affixed along with upper and lower edge of said rectangular shape housing component (102).

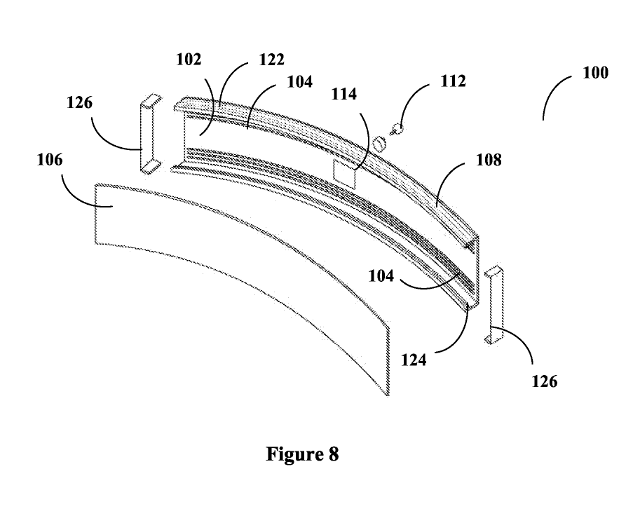

Referring to FIG. 8 is an exploded view of a curved light emitting diode (LED) fixture.

In another embodiment of the present invention, the curved light emitting diode (LED) fixture (100) is comprising of the curved, rectangular shaped housing component (102) further having said perpendicular extension (122) at both the edges of longer arm. At least three strips of LEDs (104) are affixed along with upper and lower edge of said curved rectangular shape housing component (102), along with length of said rectangular shape housing component (102), for providing multi directional light to illuminate dents on automotive vehicles. At least two rubber cushion bumper (108) affixed to outer surface of the perpendicular extension (122) of said rectangular shape housing component (102) for ensuring scratch less operation of said curved LED fixture (100) when used without a stand and laid on a painted surface of automobile. The raceway (124) affixed to inner surface of the perpendicular extension (122) of said rectangular shape housing component (102) for accommodating the white translucent lens (106). A pair of side cap (126) affixed on the both edges of the perpendicular extension (122) of said rectangular shape housing component (102) for covering opened space left between the curved, rectangular shaped housing component (102) and white translucent lens (106). The pair of metal plates (114) affixed in the middle of said rectangular shape housing component (102), from front and back side of said rectangular shape housing component (102) for supporting a brass pivotal ball (112) on said rectangular shape housing component (102)

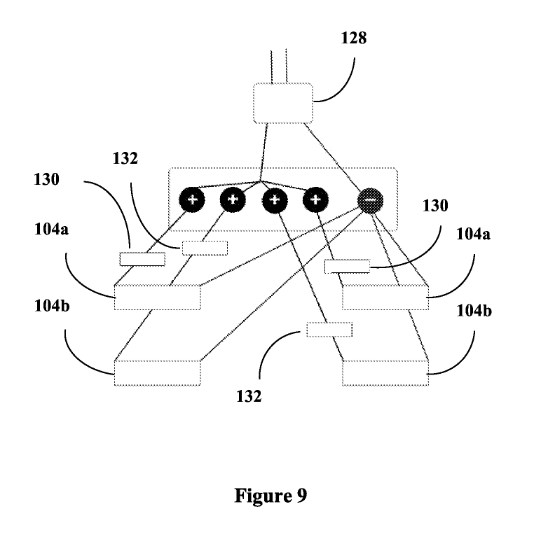

Referring to FIG. 9 is a wiring diagram of a curved light emitting diode (LED) fixture.

In another embodiment of the present invention, the curved light emitting diode (LED) fixture (100) is comprising the set of power switches (110) (not shown in the FIG. 9) further comprises of one power switch (130) operating two LED strips on the outside (104a) out of said at least three strips of LEDs (104) affixed along with upper and lower edge of said rectangular shape housing component (102); second power switch (132) operating one LED strip running in the middle (104b) out of said at least three strips of LEDs (104) affixed along with upper and lower edge of said rectangular shape housing component (102); and a master switch acting as a dimmer (128) for said at least three strips of LEDs (104) affixed along with upper and lower edge of said rectangular shape housing component (102).

The illustrations of arrangements described herein are intended to provide a general understanding of the structure of various embodiments, and they are not intended to serve as a complete description of all the elements and features of apparatus and systems that might make use of the structures described herein. Many other arrangements will be apparent to those of skill in the art upon reviewing the above description. Other arrangements may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

The preceding description has been presented with reference to various embodiments. Persons skilled in the art and technology to which this application pertains will appreciate that alterations and changes in the described structures and methods of operation can be practiced without meaningfully departing from the principle, spirit and scope.

We claim:

1) A curved light emitting diode (LED) fixture (100) for paint less dent repair (PDR) in automobiles; characterized in providing multi directional light to illuminate dents on automotive vehicles while repairing such dents; the curved LED fixture (100) comprises of:
a. a curved, rectangular shaped housing component (102) further having a perpendicular extension (122) at both the edges of longer arm of said curved, rectangular shaped housing component (102);
b. at least three strips of LEDs (104) affixed along with upper and lower edge of said rectangular shape housing component (102), along with length of said rectangular shape housing component (102), for providing multi directional light to illuminate dents on automotive vehicles;
c. a white translucent lens (106), secured on a raceway (124) affixed to inner surface of the perpendicular extension (122) of said rectangular shape housing component (102) for accommodating the white translucent lens (106); wherein the white translucent lens (106) is covering at least three strips of LEDs (104) affixed along with upper and lower edge of said rectangular shape housing component (102); wiring for providing electric supply to said at least three strips of LEDs (104) and other components of said curved light emitting diode LED fixture (100);
d. at least two rubber cushion bumper (108) affixed to outer surface of the perpendicular extension (122) of said rectangular shape housing component (102) for ensuring scratch less operation of said curved LED fixture (100) when used without a stand and laid on a painted surface of automobile;
e. a set of power switches (110) affixed at the back of said rectangular shape housing component (102) for switching on, off and dimming said at least three strips of LEDs (104) affixed along with upper and lower edge of said rectangular shape housing component (102);
f. a power cord for providing electricity supply to at least three strips of LEDs (104) affixed along with upper and lower edge of said rectangular shape housing component (102);
g. a brass pivotal ball (112) affixed in middle of said housing component (102) with the help of a nut (118) and bolt (120) for enabling said curved LED fixture (100) to rotate at different angles when affixed with a stand;
h. a pair of metal plates (114) affixed in the middle of said rectangular shape housing component (102), from front and back side of said rectangular shape housing component (102) for supporting the brass pivotal ball (112) on said rectangular shape housing component (102) and passing through the power cord; and
i. a pair of side cap (126) affixed on the both edges of the perpendicular extension (122) of said rectangular shape housing component (102) for covering opened space left between the curved, rectangular shaped housing component (102) and white translucent lens (106).

2) The curved LED fixture (100) of claim 1, wherein the curved, rectangular shaped housing component (102) is manufactured from a material selected from a group comprising of polycarbonate and polypropylene.

3) The curved LED fixture (100) of claim 1, wherein each LED strip out of the at least three strips of LEDs (104) affixed along with upper and lower edge of said rectangular shape housing component (102) is 120 cm long and evenly spaced from each end of said rectangular shape housing component (102).

4) The curved LED fixture (100) of claim 1, wherein each LED strip out of the at least three strips of LEDs (104) affixed along with upper and lower edge of said rectangular shape housing component (102) is DC 12V-3528 or 3020 of lumen.

5) The curved LED fixture (100) of claim 1, wherein each LED of said at least three strips of LEDs (104) affixed along with upper and lower edge of said rectangular shape housing component (102) is selected from a group comprising of white, yellow, blue, green colored LEDs and combination thereof.

6) The curved LED fixture (100) of claim 1, wherein the at least three strips of LEDs (104) affixed along with one of edge out of the upper and lower edge of said rectangular shape housing component (102) further comprises of two LED strips of 3000 degree kelvin on the outside with one 6500 degree kelvin LED strip running in the middle.

7) The curved LED fixture (100) of claim 1, wherein the at least three strips of LEDs (104) affixed along with the other edge out of the upper and lower edge of said rectangular shape housing component (102) further comprises of two LED strips of 6500 degree kelvin on the outside with one 3000 degree kelvin LED strip running in the middle.

8) The curved LED fixture (100) of claim 1, wherein the white translucent lens (106), covering at least three strips of LEDs (104) affixed along with upper and lower edge of said rectangular shape housing component (102) is of the equal size of said housing component (102).

9) The curved LED fixture (100) of claim 1, wherein the white translucent lens (106), covering at least three strips of LEDs (104) affixed along with upper and lower edge of said rectangular shape housing component (102) is manufactured from a material selected from a group comprising of acrylic.

10) The curved LED fixture (100) of claim 1, wherein the set of power switches (110) further comprises of one power switch (130) operating two LED strips on the outside (104a) out of said at least three strips of LEDs (104) affixed along with upper and lower edge of said rectangular shape housing component (102); second power switch (132) operating one LED strip running in the middle (104b) out of said at least three strips of LEDs (104) affixed along with upper and lower edge of said rectangular shape housing component (102); and a master switch acting as a dimmer (128) for said at least three strips of LEDs (104) affixed along with upper and lower edge of said rectangular shape housing component (102).

11) The curved LED fixture (100) of claim 1, wherein the power cord for providing electricity supply to at least three strips of LEDs (104) affixed along with upper and lower edge of said rectangular shape housing component (102); is 500 cm long coiled cord and comprising of 16 or 14 gauge insulated copper wire.

12) The curved LED fixture (100) of claim 1, wherein the power cord for providing electricity supply to at least three strips of LEDs (104) affixed along with upper and lower edge of said rectangular shape housing component (102) has 12 v automotive cigarette lighter male plug on the end.

13) The curved LED fixture (100) of claim 1, wherein the pair of metal plate (112) affixed in the middle of said rectangular shape housing component (102) is manufactured from a material selected from a group comprising of power coated aluminum and steel and is having dimensions of 100 mm×75 mm×2 mm.
